(19) United States
(12) Patent Application Publication
(10) Pub. No.: US 2019/0149026 A1
(43) Pub. Date: May 16, 2019

(54) METHOD FOR MANUFACTURING BRUSH DC MOTOR

(71) Applicant: MITSUBISHI ELECTRIC CORPORATION, Tokyo (JP)

(72) Inventor: Hodaka SAITO, Tokyo (JP)

(73) Assignee: MITSUBISHI ELECTRIC CORPORATION, Tokyo (JP)

(21) Appl. No.: 16/099,262

(22) PCT Filed: Jun. 28, 2016
(86) PCT No.: PCT/JP2016/069108

§ 371 Date: Nov. 6, 2018

(51) Int. Cl. H02K 15/14; H02K 5/14; H01R 43/12; B29C 65/54

(52) U.S. Cl. CPC H02K 15/14; H02K 5/148; B29L 2031/3481; B29C 65/542; H01R 43/12

(57) ABSTRACT

A protrusion (71) of a case (7) is inserted into a groove (9) on which a wire (10) is placed. The case (7) is pressed toward the bottom of the groove (9) until a brush holder (5) and a stepped surface (72) come into contact with each other while the bottom of the groove (9) is heated by heat generation of the wire (10), in which a clearance (C1) between the brush holder (5) and the stepped surface (72) is smaller than a clearance (C2) between an exterior case (3) and a stepped surface (73).

### TECHNICAL FIELD

The present invention relates to a method for manufacturing a brush direct current (DC) motor for preventing a welding burr from entering the interior of the brush DC motor.

### BACKGROUND ART

For example, Patent Literature 1 discloses an electric oil pump device in which a burr due to welding is housed in an axial gap formed between a sliding contact protrusion of a lid made of resin and each of inner and outer circumferential sidewalls extending in the axial direction at an annular groove of a motor housing made of resin.

### CITATION LIST

### Patent Literature

Patent Literature 1: JP 2013-122234 A

### SUMMARY OF INVENTION

### Technical Problem

However, in the electric oil pump device of Patent Literature 1 described above, a gap in the radial direction is formed between the inner circumferential sidewall and the sliding contact protrusion of the lid. For this reason, in a case where an amount of resin melted by welding reaches equal to or more than an estimated amount, or the like, there is a possibility that the molten resin enters the motor interior through the gap in the radial direction and becomes a burr. In a case where the burr enters the motor interior, there is a possibility that malfunction of the motor is caused by biting of the burr.

The present invention has been made to solve problems as described above, and it is an object of the present invention to provide a method for manufacturing a brush DC motor that can inhibit a burr due to welding from entering the motor interior.

### Solution to Problem

A method for manufacturing a brush DC motor according to the present invention includes: a first step of inserting a protrusion of a case into a groove formed around an opening of an exterior case by covering the opening with a brush holder; and a second step of pressing the case toward a bottom of the groove until the brush holder and a stepped surface on an interior side of the case as viewed from the protrusion come into contact with each other while heating the bottom of the groove, in which a clearance between the brush holder and the stepped surface on the interior side is smaller than a clearance between the exterior case and a stepped surface on an exterior side of the case as viewed from the protrusion.

### Advantageous Effects of Invention

According to the present invention, not the exterior case and the stepped surface on the exterior side as viewed from the protrusion, but the brush holder and the stepped surface on the interior side as viewed from the protrusion are brought into contact with each other, whereby a burr due to welding can be inhibited from entering the motor interior.

### BRIEF DESCRIPTION OF DRAWINGS

FIG. 1 is a cross-sectional view illustrating a brush DC motor manufactured by a manufacturing method according to a first embodiment of the present invention.

FIG. 2 is an enlarged cross-sectional view of a portion A in FIG. 1.

FIG. 3 is a cross-sectional view illustrating an appearance of the portion A before welding.

FIG. 4 is a cross-sectional view illustrating an appearance of the portion A before welding.

FIG. 5 is a reference diagram to help understanding of the manufacturing method according to the first embodiment of the present invention.

FIG. 6 is a cross-sectional view illustrating an appearance of the portion A before welding by a manufacturing method according to a second embodiment of the present invention.

FIG. 7 is a cross-sectional view illustrating a modification of the manufacturing method according to the second embodiment of the present invention.

FIG. 8 is a cross-sectional view illustrating a modification of the manufacturing method according to the second embodiment of the present invention.

### DESCRIPTION OF EMBODIMENTS

Hereinafter, in order to explain the present invention in more detail, embodiments for carrying out the present invention will be described with reference to the accompanying drawings.

### First Embodiment

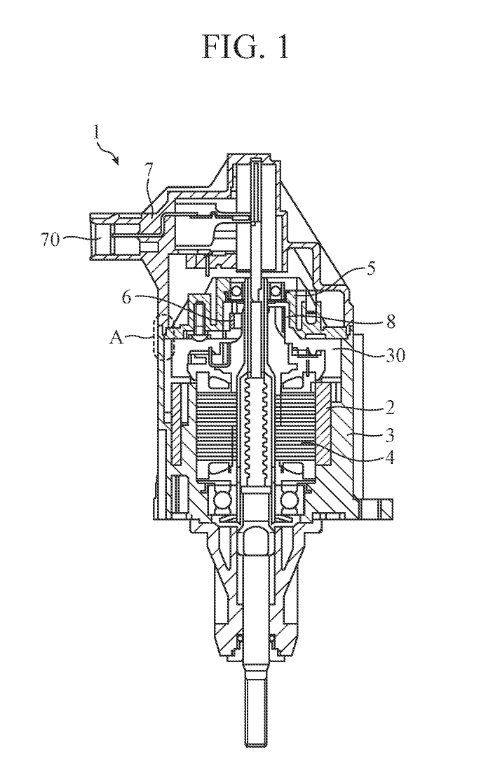

FIG. 1 is a cross-sectional view illustrating a brush direct current (DC) motor 1 manufactured by a manufacturing method according to a first embodiment of the present invention. In the brush DC motor 1, a rotor 4 including a coil is rotatably housed in the interior of an exterior case 3 having a substantially cylindrical shape in which a magnet 2 is fixed on the inner circumferential surface. An opening 30 in the upper part of the exterior case 3 in the figure is covered with a brush holder 5. The brush holder 5 holds a brush 6. In addition, a case 7 including a connector 70 is attached covering the brush holder 5.

The brush DC motor 1 is connected to an external power supply (not illustrated) via the connector 70. As is well known, DC current supplied via the connector 70 is supplied via the brush 6 and then a commutator 8 to the coil of the rotor 4, and the rotor 4 rotates.

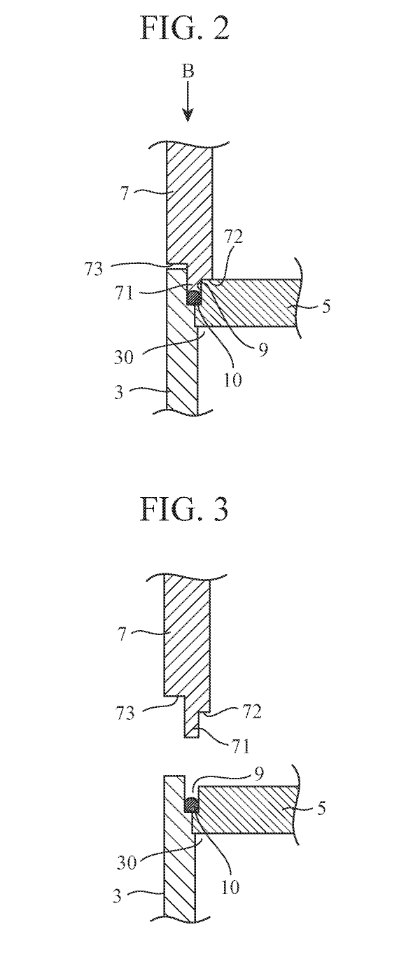

FIG. 2 is an enlarged cross-sectional view of a portion A in FIG. 1. The opening 30 of the exterior case 3 is covered with the brush holder 5, whereby a groove 9 having an annular shape as viewed from a direction B in FIG. 2 is formed around the opening 30 by the exterior case 3 and the brush holder 5.

The case 7 includes a protrusion 71 fixed in a state of being inserted into the groove 9 having an annular shape. The protrusion 71 is formed in an annular shape as viewed from a direction opposite to the direction B in FIG. 2. A stepped surface 72 located on the interior side of the brush DC motor 1 as viewed from the protrusion 71 is in contact with the brush holder 5, and a stepped surface 73 located on the exterior side of the brush DC motor 1 as viewed from the protrusion 71 faces the exterior case 3 with a gap therebetween.

A wire 10 having an annular shape is placed on the bottom of the groove 9, and the exterior case 3, the brush holder 5, and the case 7 around the wire 10 are welded to each other. The exterior case 3, the brush holder 5, and the case 7 are each made of resin, for example, polyphenylene sulfide (PPS), or the like.

Next, a process for welding the exterior case 3, the brush holder 5, and the case 7 to each other will be described.

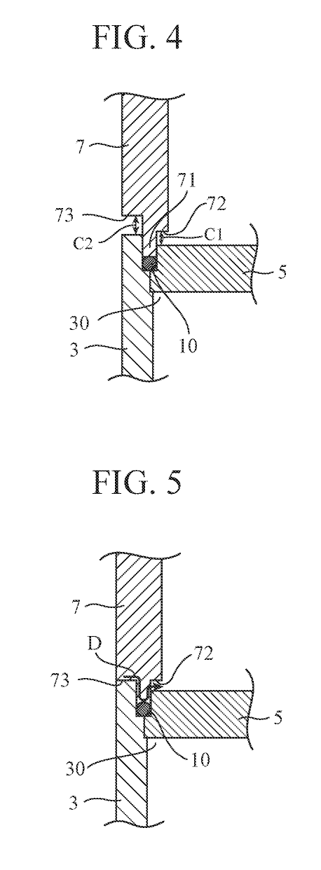

FIGS. 3 and 4 are each a cross-sectional view illustrating an appearance of the portion A before welding.

The opening 30 of the exterior case 3 is covered with the brush holder 5, and the groove 9 having an annular shape is formed around the opening 30 by the exterior case 3 and the brush holder 5. In the groove 9, the wire 10 is placed.

In addition, the protrusion 71 having an annular shape of the case 7 is longer than the one after welding illustrated in FIG. 2.

First, from a state illustrated in FIG. 3, the protrusion 71 of the case 7 is inserted into the groove 9. FIG. 4 illustrates a state when the protrusion 71 is inserted. Dimensions of portions of the exterior case 3, the brush holder 5, and the case 7 are designed so that a clearance C1 between the brush holder 5 and the stepped surface 72 on the interior side as viewed from the protrusion 71 is smaller than a clearance C2 between the exterior case 3 and the stepped surface 73 on the exterior side as viewed from the protrusion 71, in the state of FIG. 4.

Subsequently, while the bottom of the groove 9 is heated by causing the wire 10 to generate heat, the case 7 is pressed toward the bottom of the groove 9. As a result, the tip of the protrusion 71 is melted, and the case 7 moves downward in the figure. Then, since the clearance C1 is smaller than the clearance C2, when the case 7 continues moving, not the exterior case 3 and the stepped surface 73, but the brush holder 5 and the stepped surface 72 come into contact with each other. When the brush holder 5 and the stepped surface 72 come into contact with each other, heat generation of the wire 10 and pressing of the case 7 are stopped.

FIG. 2 illustrates an appearance of the portion A after the exterior case 3, the brush holder 5, and the case 7 are welded to each other by so-called hot wire welding as described above.

The dimensions of portions of the exterior case 3, the brush holder 5, and the case 7 are designed so that the molten resin does not overflow the groove 9 at the time of welding. However, in a case where the amount of the molten resin reaches equal to or more than an estimated amount due to dimensional errors, various external factors at the time of welding, and the like, the resin may overflow the groove 9.

At that time, as illustrated in a reference example of FIG. 5, if not the brush holder 5 and the stepped surface 72, but the exterior case 3 and the stepped surface 73 come into contact with each other first, the molten resin overflowing into between the exterior case 3 and the stepped surface 73 is pushed back in a direction of an arrow D in FIG. 5. Then, the molten resin enters the interior of the brush DC motor 1 through the clearance between the brush holder 5 and the stepped surface 72. The resin having entered solidifies and becomes a burr, and may cause malfunction of the brush DC motor 1.

On the other hand, as described with reference to FIGS. 2 to 4, in a case where the brush holder 5 and the stepped surface 72 come into contact with each other first, the resin is not pushed back in the direction of the arrow D in FIG. 5. In addition, since the clearance C1 is smaller than the clearance C2, the molten resin is more likely to flow toward the clearance C2, that is, the exterior of the brush DC motor 1 than toward the clearance C1.

As described above, the burr due to welding can be inhibited from entering the interior of the brush DC motor 1.

Note that, in the above, as an example, the case where the hot wire welding is used for welding the exterior case 3, the brush holder 5, and the case 7 to each other has been described; however, ultrasonic welding may be used. This also applies to a second embodiment to be described later.

As described above, with the method for manufacturing the brush DC motor 1 according to the first embodiment, the protrusion 71 is inserted into the groove 9, and the case 7 is pressed toward the bottom of the groove 9 while the bottom of the groove 9 is heated, in which the clearance C1 between the brush holder 5 and the stepped surface 72 is smaller than the clearance C2 between the exterior case 3 and the stepped surface 73. In this way, the burr due to welding is inhibited from entering the interior of the brush DC motor 1.

### Second Embodiment

In a second embodiment, a manufacturing method for further inhibiting the burr from entering the interior of the brush DC motor 1 as compared with the first embodiment will be described.

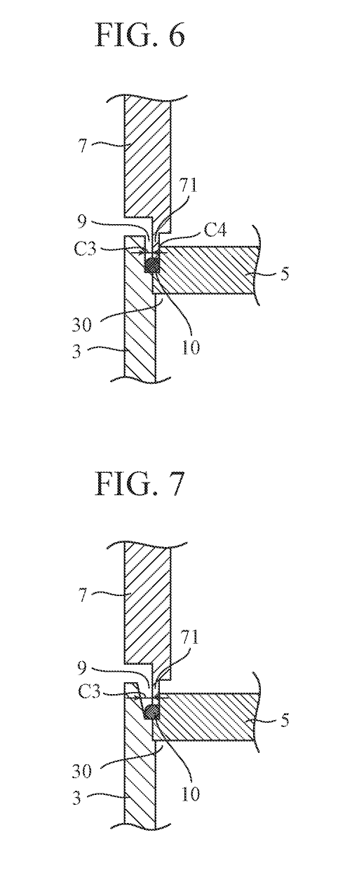

FIG. 6 is a cross-sectional view illustrating an appearance of the portion A before welding. As illustrated in the figure, a clearance C3 between the exterior case 3 and the outer circumferential surface of the protrusion 71 having an annular shape is larger than a clearance C4 between the brush holder 5 and the inner circumferential surface of the protrusion 71. In FIG. 6, a case where the clearance C4 is approximately 0 is illustrated as an example.

Steps of inserting the protrusion 71 into the groove 9 and pressing the case 7 toward the bottom of the groove 9 while heating the bottom of the groove 9 by the wire 10 are the same as those in the first embodiment.

As illustrated in FIG. 6, by setting the clearance C3 to be larger than the clearance C4 when the protrusion 71 is inserted into the groove 9, the resin melted by heating by the wire 10 is more likely to flow toward the clearance C3 than the clearance C4. In this way, by guiding the molten resin to the clearance C3, the burr can be further inhibited from entering the interior of the brush DC motor 1 as compared with the first embodiment.

In FIG. 6, the clearance C3 is made larger than the clearance C4 by making the protrusion 71 to be thinner than that in FIGS. 2 to 4; however, the clearance C3 may be made larger than the clearance C4 by widening the width of the groove 9 toward the exterior side of the brush DC motor 1, instead of making the protrusion 71 thinner than that in FIGS. 2 to 4.

Note that, as illustrated in FIG. 7, when the protrusion 71 is inserted into the groove 9, the clearance C3 between the exterior case 3 and the outer circumferential surface of the protrusion 71 may be made smaller toward the bottom of the groove 9. In this way, the resin melted by heating by the wire 10 can be more easily guided to the clearance C3.

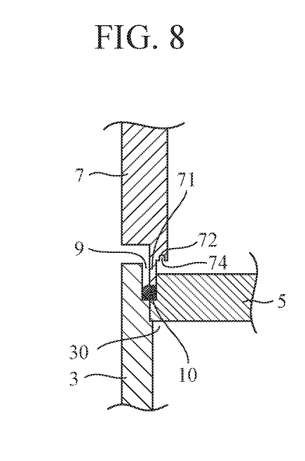

In addition, as illustrated in FIG. 8, a recess 74 may be formed in the stepped surface 72. In a case where the resin melted by heating by the wire 10 flows toward the interior of the brush DC motor 1, the resin is guided to the recess 74 and stored in the recess 74. In this way, the molten resin can be inhibited from further entering the interior of the brush DC motor 1 beyond the recess 74.

In addition, the recess 74 may be formed in the stepped surface 72 while the clearance C3 between the exterior case 3 and the outer circumferential surface of the protrusion 71 is made smaller toward the bottom of the groove 9.

As described above, with the method for manufacturing the brush DC motor 1 according to the second embodiment, the clearance C3 between the exterior case 3 and the outer circumferential surface of the protrusion 71 is made larger than the clearance C4 between the brush holder 5 and the inner circumferential surface of the protrusion 71. As a result, the burr can be further inhibited from entering the interior of the brush DC motor 1 as compared with the first embodiment.

In addition, the clearance C3 between the exterior case 3 and the outer circumferential surface of the protrusion 71 in a state of being inserted into the groove 9 is smaller toward the bottom of the groove 9, and the molten resin is guided to the clearance C3 between the exterior case 3 and the outer circumferential surface of the protrusion 71. In this way, the burr can be further inhibited from entering the interior of the brush DC motor 1.

In addition, the recess 74 is formed in the stepped surface 72 on the interior side, and the molten resin is guided to the recess 74. In this way, the molten resin can be inhibited from further entering the interior of the brush DC motor 1 beyond the recess 74.

Note that, in the invention of the present application, within the scope of the invention, free combination of each embodiment, a modification of any component of each embodiment, or omission of any component in each embodiment is possible.

### INDUSTRIAL APPLICABILITY

As described above, the method for manufacturing a brush DC motor according to the present invention can inhibit the burr due to welding from entering the motor interior, so that the method is suitable for manufacturing a brush DC motor with less malfunction.

### REFERENCE SIGNS LIST

1: Brush DC motor, 2: Magnet, 3: Exterior case, 4: Rotor, 5: Brush holder, 6: Brush, 7: Case, 8: Commutator, 9: Groove, 10: Wire, 30: Opening, 70: Connector, 71: Protrusion, 72, 73: Stepped surface, 74: Recess.

1. A method for manufacturing a brush DC motor including an exterior case which is made of resin and houses a rotor, a brush holder made of resin, and a case which is made of resin and covers the brush holder,
the method comprising:
a first step of inserting a protrusion of the case into a groove formed around an opening of the exterior case by covering the opening with the brush holder; and
a second step of pressing the case toward a bottom of the groove until the brush holder and a stepped surface on an interior side of the case as viewed from the protrusion come into contact with each other while heating the bottom of the groove, wherein a clearance between the brush holder and the stepped surface on the interior side is smaller than a clearance between the exterior case and a stepped surface on an exterior side of the case as viewed from the protrusion.

2. The method for manufacturing a brush DC motor according to claim 1, further comprising a third step of guiding resin melted in the second step to a clearance between the exterior case and an outer circumferential surface of the protrusion, wherein the clearance between the exterior case and the outer circumferential surface of the protrusion in a state of being inserted into the groove in the first step is larger than a clearance between the brush holder and an inner circumferential surface of the protrusion in the state.

3. The method for manufacturing a brush DC motor according to claim 2, further comprising a fourth step of guiding the resin melted in the second step to the clearance between the exterior case and the outer circumferential surface of the protrusion, wherein the clearance between the exterior case and the outer circumferential surface of the protrusion in the state of being inserted into the groove in the first step is smaller toward the bottom of the groove.

4. The method for manufacturing a brush DC motor according to claim 2, further comprising a fifth step of guiding the resin melted in the second step to a recess formed in the stepped surface on the interior side.
